(19) United States
(12) Patent Application Publication
(10) Pub. No.: US 2024/0212332 A1
(43) Pub. Date: Jun. 27, 2024

(54) FATIGUE LEVEL DETERMINATION METHOD USING MULTIMODAL TENSOR FUSION

(71) Applicant: VAIV Company Inc., Seoul (KR)

(72) Inventors: Chang-Won Ahn, Daejeon (KR); Soungwoong Yoon, Goyang-si (KR); Jongwoo Ha, Seoul (KR); Joon-Hyuck Ryu, Seoul (KR)

(21) Appl. No.: 18/085,707

(22) Filed: Dec. 21, 2022

(51) Int. Cl. G06V 10/80; G06V 10/77; G10L 25/63

(52) U.S. Cl. CPC G06V 10/811; G06V 10/7715; G06V 10/806; G10L 25/63

(57) ABSTRACT

Provided is a fatigue level determination method in which an information system having a deep learning algorithm including a tensor fusion network receives and analyzes a video image and a thermal image captured with a subject's face included, and a subject's voice recorded simultaneously therewith in a multimodal manner and determines a current fatigue level of the subject. The information system receives a video image, a thermal image, and a voice simultaneously captured and recorded from a subject for a certain time as an analysis target multimodality, makes the input video image, thermal image, and voice into feature tensors, extends the dimensions thereof, inputs the resulting feature tensors to a tensor fusion network to generate a fusion tensor, transmits the generated fusion tensor to a fully connected layer, and determines the fatigue level.

### BACKGROUND

### 1. Field of the Invention

The present disclosure relates to a fatigue level determination method using multimodal tensor fusion. More particularly, the present disclosure relates to a fatigue level determination method in which an information system receives an image and a thermal image captured such that the face of a subject is included therein, as well as voice of the subject recorded simultaneously with the images, in a multimodal manner, analyzes the images and the voice, and determines a current fatigue level of the subject using a deep learning algorithm including a tensor fusion network.

### 2. Description of Related Art

Events involving temporal changes may be converted into data similarly to a method by which humans perceive sensations, which is referred to as modality. Data of an event may be observed in various modalities. Comprehensive determination of these modalities has qualitative factors that are difficult to quantitatively represent, such as emotions or external conditions, added thereto appear as the result of the event. Attempts to predict results by analyzing data are ongoing.

Recently, multimodal learning has emerged in machine learning. This method aims to provide a better understanding of a given event by using multiple modalities. Multimodal learning has been mainly used to perform learning by transitioning from one modality to another modality in a specific situation or learning multiple modalities together so as to achieve a specific analysis purpose. Major researches include image determination through text data, text determination through image data, voice modal-based model, and the like. The field of research is expanding to sentiment analysis, natural language processing, and the like.

In addition, people living in modern society suffer from chronic fatigue due to complicated and irregular lifestyles. It is known that fatigue is caused by physiological characteristics, sleep disorders, personal life characteristics, stress, living environments, and various activities for health maintenance. Fatigue accumulated in people has a very significant effect on their work. Fatigue affects work performance by involving decreased concentration, reduced decision-making ability, and delayed response time, leading to a decline in work performance.

In particular, in the case of workers in special occupations, such as pilots of aircrafts or fighter jets or operators of precision weapon systems who are required to maintain a high level of concentration when performing their duties or workers, such as ship crew or long-distance drivers, who are required to work for long hours and make quick and accurate judgment in the event of an unexpected situation, when the workers are put into work or combat in a state of high fatigue, their cognitive function may deteriorate, the possibility of accidents may increase, and combat power may be greatly reduced. Accordingly, there is a need to strictly operate a system that allows people with high fatigue level to be screened out in advance and excluded from duty, training, or combat.

In other words, it is desirable to objectively measure fatigue levels of workers or combat personnel so as to exclude those with a certain fatigue level or higher from duty, training, or combat. In this regard, a method or a system that is capable of objectively measuring a fatigue level is required. However, the concept of human fatigue is not clearly distinguished, and even people themselves cannot easily determine a fatigue level. Accordingly, it is difficult to filter out people with high fatigue levels on the basis of objective standards.

In addition, due to the development of machine learning and artificial intelligence (AI) technologies, attempts to analyze a lot of data and use the analyzed data in various fields are ongoing. In particular, with the development of image analysis technologies in the field of computer vision, analysis results that reach the realm of human judgment are shown in certain fields. Image analysis technology, such as behavioral analysis, may measure human conditions and behaviors and effectively analyze subsequent behaviors or emotions.

Recently, research has been conducted to measure fatigue by collecting fatigue-related data and learning a deep learning model. Typically, research has been conducted to measure fatigue by collecting body movement-related data through sensors or to measure fatigue by continuously capturing a driver for a long time and learning the driver's eye blinking and changes in the shape of the driver's pupils and irises. However, since these methods perform analysis on the basis of images obtained by capturing a subject for a long time, there has been a problem that these methods cannot be used for a fatigue test that has to quickly determine a fatigue level of a subject immediately before duty, training, or combat participation.

### SUMMARY

Various aspects of the present disclosure provide a fatigue level determination method in which an information system uses a deep learning algorithm including a tensor fusion network to receive and analyze an image and a thermal image obtained by capturing a subject and a subject's voice recorded simultaneously therewith in a multimodal manner and determine a current fatigue level of the subject.

Also provided is a fatigue level determination method for measuring a current fatigue level of a subject by using an image and a thermal image obtained by capturing a subject's face for a relatively short time and a recorded voice, without using an image or data obtained by capturing or observing the subject for a long time.

According to an aspect, a fatigue level determination method using multimodal tensor fusion, in which an information system determines a person's fatigue level by analyzing a video image and a thermal image captured from the face of a person and a voice recorded from the person by an algorithm using tensor fusion includes: a first operation of receiving a video image, a thermal image, and voice simultaneously captured and recorded from a subject for a certain time as an analysis target of the subject; a second operation of decomposing the video image and the thermal image received as the analysis target in frame units; a third operation of selecting an analysis target video image frame and an analysis target thermal image frame from among frames of the video image and the thermal image decomposed in the second operation; a fourth operation of generating a video image feature tensor z^{v} from the analysis target video image frame; a fifth operation of generating a voice feature tensor z^{a} from voice data received as the analysis target; a sixth operation of generating a thermal image feature tensor z^{h} from the analysis target thermal image frame; a seventh operation of extending dimensions of the video image feature tensor z^{v}, the voice feature tensor z^{a}, and the thermal image feature tensor z^{h}; an eighth operation of generating a fusion tensor z_{fusion} by inputting the video image feature tensor z^{v}, the voice feature tensor z^{a}, and the thermal image feature tensor z^{h}, whose dimensions are extended in the seventh operation, to a tensor fusion network (TFN) and performing an operation thereon in a Cartesian product method; and a ninth operation of transmitting the fusion tensor z_{fusion} to a fully connected layer and classifying fatigue levels.

In addition to the above-described features, in the fourth operation, a video image embedding submodel using an efficient net may reduce the analysis target video image frame fᵢ^{j} into a 3-channel video image, may perform vector embedding by extracting video image feature elements zᵢ^{j} in a vector format, and may concatenate all of the video image feature elements zᵢ^{j} into one element to generate the video image feature tensor z^{v} as follows:

z^{v}=(zᵢ¹,zᵢ², . . . zᵢ^{k}), |z^{v}|=k*|zᵢ^{j}| where 0<i≤n (n: dataset size)
0<j≤k.

Alternatively, in the fourth operation, a video image embedding subnet may reduce, to one-dimensional vectors zᵢ^{j}, the analysis target video image frame fᵢ^{j} through an operation to which a global average pooling (GAP) layer and a channel extension through a dense net are applied, and may concatenate the one-dimensional vectors zᵢ^{j} into one vector to generate the video image feature tensor z^{v} as follows:

z^{v}=(zᵢ¹,zᵢ², . . . zᵢ^{k}), |z^{v}|=k*|zᵢ^{j}| where 0<i≤n (n: dataset size)
0<j≤k.

In addition to the above-described features, in the fifth operation, a voice embedding submodel may perform vector embedding by extracting F0-mean values for each specific section t with respect to i^{th} voice data aᵢ among the voice data, and may concatenate all of the F0-mean values into one value to generate the voice feature tensor z^{a} as follows:

$${z}^{a} = ( F {{0}_{i}}^{1} , F {{0}_{i}}^{2} , … , F {{0}_{i}}^{\frac{T}{i}} ) where 0 〈 i \leq n ( n : dataset size ) .$$

In addition, in the fifth operation, a voice embedding subnet may transmit, to a fully connected layer (FCL), data for i^{th} voice data aᵢ among the voice data to generate the voice feature tensor z^{a}.

In addition to the above-described features, in the sixth operation, a thermal embedding submodel using an efficient net may perform vector embedding by extracting thermal image feature elements zᵢ^{j} in a vector format from the analysis target thermal image frame hfᵢ^{j}, and may concatenate all of the thermal image feature elements zᵢ^{j} into one element to generate the thermal image feature tensor z^{h} as follows:

z^{h}=(zᵢ¹,zᵢ², . . . zᵢ^{k}), |z^{h}|=k*|zᵢ^{j}| where 0<i≤n (n: dataset size)
0<j≤k.

In addition, in the sixth operation, a thermal embedding subnet may reduce, to one-dimensional vectors zᵢ^{j}, the analysis target video image frame hfᵢ^{j} through an operation to which a GAP layer and a channel extension through a dense net are applied, and may concatenate the one-dimensional vectors zᵢ^{j} into one vector to generate the thermal image feature tensor z^{h} as follows:

z^{v}=(zᵢ¹,zᵢ², . . . zᵢ^{k}), |z^{v}|=k*|zᵢ^{j}| where 0<i≤n (n: dataset size)
0<j≤k.

In addition to the above-described features, in the seventh operation, when the dimensions of the video image feature tensor z^{v}, the voice feature tensor z^{a}, and the thermal image feature tensor z^{h} are extended, the dimensions of the video image feature tensor z^{v}, the voice feature tensor z^{a}, and the thermal image feature tensor z^{h} may be filled with a value of 1.

According to the above-described embodiments, since the present disclosure provides the fatigue level determination method in which the information system analyzes the video image and the thermal image obtained by capturing the face of a person for a relatively short time and the voice recorded simultaneously therewith, and determines the current fatigue level of the person, there is an effect of measuring the fatigue level of the subject quickly and accurately.

In addition, since the present disclosure does not analyze only one modality, but receives and analyzes multiple modalities, such as video images, thermal images, and voices, which are capable of detecting the fatigue level of the person, there is an effect of determining the fatigue level of the subject more accurately.

In addition, since the present disclosure receives a video image, a thermal image, and voice of a subject simultaneously captured and recorded for a certain time in a multimodal manner, makes the modalities, such as the input video image, thermal image, and voice into feature tensors, extends the dimensions thereof, inputs the resulting feature tensors to the tensor fusion network to generate the fusion tensor, transmits the generated fusion tensor to the fully connected layer, and determines the fatigue level, it is possible to define the tensor for fusion by reducing and processing the data while maintaining the meaning of the input data as much as possible. Accordingly, there is an effect of solving the problem of unevenness of the input data despite a large difference in the shape and size of each input data, i.e., video image, voice, and thermal image.

### BRIEF DESCRIPTION OF DRAWINGS

The above and other objectives, features, and advantages of the present disclosure will be more clearly understood from the following detailed description, taken in conjunction with the accompanying drawings, in which:

FIG. 1 is a conceptual diagram illustrating a concept of generating a fusion tensor using tensor fusion by extracting a feature tensor of each modality using a submodel included in the present disclosure;

FIG. 2 is a configuration diagram of an image embedding submodel included in the present disclosure;

FIG. 3 is a configuration diagram of a voice embedding submodel included in the present disclosure;

FIG. 4 is a conceptual diagram illustrating a concept of generating a fusion tensor using tensor fusion by extracting a feature tensor of each modality using a subnet included in the present disclosure;

FIG. 5 is a configuration diagram of an image embedding subnet included in the present disclosure;

FIG. 6 is a configuration diagram of a voice embedding subnet included in the present disclosure;

FIG. 7 illustrates a data collection procedure in an experiment for verifying the present disclosure;

FIG. 8 illustrates an example in which an image, a thermal image, and voice data are collected in an experiment for verifying the present disclosure; and

FIG. 9 illustrates comparison of measurement results of each modality in an experiment for verifying the present disclosure.

### DETAILED DESCRIPTION

Hereinafter, reference will be made to exemplary embodiments of the present disclosure in detail, examples of which are illustrated in the accompanying drawings and described below, so that a person having ordinary skill in the art to which the present disclosure relates could easily practice the embodiments of the present disclosure. In the following description, detailed descriptions of known functions and components incorporated in the present disclosure will be omitted in the case in which the subject matter of the present disclosure is rendered unclear (or may be rendered unclear thereby).

Embodiments may be modified in various forms and may have various additional embodiments. Specific embodiments are shown in the drawings and related detailed descriptions are described. However, this is not intended to limit exemplary embodiments to specific forms, and it should be understood that the present disclosure includes all changes, equivalents, and substitutes falling within the spirit and technical scope of the exemplary embodiments.

In general, multimodal learning has used one modality as a criterion for determining another modality by analyzing quantitative data. There are also studies on qualitative results, such as the generation of images from text data, but these are cases found in the course of analysis and have not been studied for evaluation purposes.

In the present disclosure, a method of classifying a specific state of an event represented with qualitative data through quantitative data analysis is proposed and was verified through experiments. A model is proposed by defining data of a video image, voice, and a thermal image that are most representative to represent an event as a modality, comprehensively analyzing the video image, voice, and thermal image data through tensor fusion networks (TFNs), and classifying fatigue levels of a subject that may be referred to as complex qualitative data. Experimental results showed that the multimodal model was superior to a unimodal model using each single modality. This means that the multimodal analysis method can extract qualitative determination more effectively than the unimodal analysis using the same data. In order to examine this phenomenon, a data input operation was divided and the effect of each modality and the combination effect thereof were compared and analyzed, and it was experimentally shown that as the multimodal dimension increased, the analysis effect increased.

Referring to the results that may be obtained through the present disclosure, the methodology for confirming whether a given problem can be viewed and solved from a complex viewpoint by combining multiple effects that can be obtained from unimodal data, in particular, whether it is effective in achieving an index related to qualitative evaluation criteria is proven through experiments. In particular, this may provide implications for artificial intelligence (AI) research, such as empirical and intelligent determination using human complex perception as input. In addition, there is provided a method that may discover new direction of analysis, such as viewpoints and intentions, through comparison of an effect obtained by combining results of analyzing input data with a state-of-the-art (SOTA) model of a corresponding modality and an effect obtained by combining and analyzing a representation of input data.

Multimodal learning or multimodal AI is expanding its research area. There are studies to present many ideas and models, such as image tagging, image captioning, image, visual question answering, scene recognition by sound, and Speech2Face. The given problem of various studies is to improve an effect of an existing modality by adding other modalities or to reach a new target modality through existing modal analysis. Convergence of multiple modalities is a fundamental approach to problem solving through multimodal learning. The most basic method is early fusion that is a method of concatenating feature vectors derived from each modality.

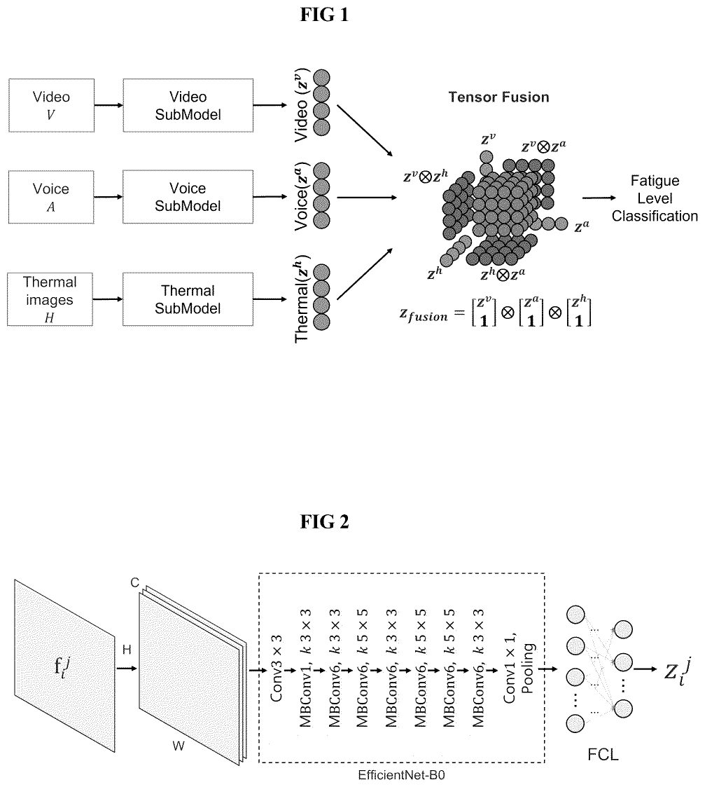

However, multimodal model learning is a difficult task due to a difference in form or representation between data representing each modality, a difference in feature space, and the like, and may lead to a biased result for a particular modality. Recent attempts for multimodal learning suggest the importance of appropriate use of tensors for multimodal representation. In the present disclosure, a TEN method is applied to represent and control the multimodality through meaningful operations of tensors, and related models are proposed. Experiments were conducted thereon. FIG. 1 illustrates a multimodal tensor representation method of a TFN.

A particular meaning appears as an action. Motion detection in an image is used to find a particular meaning or emotion in an image or a frame constituting the image. A histogram of oriented gradients (HOG) used not only a face image seen from the front but also a natural pose image. UCF101 Action Recognition Data Set defines 101 activity classes, includes 13,000 clips and 27 hours of video image data, and is used to analyze human activity. Recently, convolution-3D has been used. The present disclosure proposes a quantitative analysis method for finding a comprehensive meaning such as fatigue, rather than a practically generalized method such as behavior/activity recognition.

The present disclosure provides a fatigue level measurement model (fTFN) through a tensor fusion method. The present disclosure is realized by configuring a multimodal learning method in which three modalities including a video image, voice, and a thermal image are represented in quantitative data, in order to derive a fatigue level, i.e., data represented in a qualitative state. Through the present disclosure, the input tensors of the processed three modalities or the features extracted through a submodel or subnet for each input data are appropriately fused and the model is learned to derive the fatigue level.

The method according to the present disclosure utilizes the tensor fusion method of the TEN, but there is a difference in a feature extraction or data processing method for each input and data type. The tensor of the TEN is a feature derived through vector embedding by applying a submodel to each modality. However, the present disclosure focuses on reducing the dimension of input data and representing raw data as it is, rather than extracting features for input data of each modality by applying a separate subnet. These methods are meaningful for solving practical problems, including qualitative data that are difficult to represent with tensors. Therefore, a first model (fTFN 1) of the present disclosure is defined by defining an input processing process proposed by an existing TEN as a submodel method, and a second model (fTFN 2) applying the subnet method is also provided. In order to prove the result of the present disclosure, the two models were defined and a comparative experiment was conducted. In addition, in the present disclosure, respective systems were compared and analyzed through experiments in a unimodal method of deriving a fatigue level by using a single modality. In a unimodal system, the fatigue level is derived through a fully connected layer (FCL) after tensorization of modal input data in order to determine whether each modality could independently derive the fatigue level without interference between modalities.

In this regard, after performing a first operation of receiving a video image, a thermal image, and a voice simultaneously captured and recorded from a subject, whose fatigue level is to be measured, for a certain time as an analysis target of the subject, it is desirable to perform a second operation of decomposing the video image and the thermal image received as the analysis target in frame units. In addition, it is desirable to perform a third operation of selecting an analysis target video image frame and an analysis target thermal image frame from among frames of the video image and thermal image decomposed in the second operation.

In the third operation of selecting the analysis target video image frame and the analysis target thermal image frame, it is also desirable to extract the analysis target frame in certain time units. However, it is also possible to perform random extraction or to apply a key frame extraction method. Among them, since the key frame extraction method does not need to analyze all the same or similar frames, the key frame extraction method is a method of measuring fatigue by separately selecting only key frame images that are meaningful for analysis, such as frames at the time when there is a change of a certain size or more in facial movement or posture, rather than targeting all frames included in one video image. This will be described below.

After performing the third operation of selecting the analysis target image frame and the analysis target thermal image frame, it is desirable to perform a fourth operation of generating a video image feature tensor z^{v} from the analysis target video image frame by using a submodel or subnet for each modality, a fifth operation of generating a voice feature tensor z^{a} from voice data received as the analysis target, and a sixth operation of generating a thermal image feature tensor z^{h} from the analysis target thermal image frame.

After generating the feature tensors for each modality, it is desirable to perform a seventh operation of extending the dimensions of the video image feature tensor z^{v}, the voice feature tensor z^{a}, and the thermal image feature tensor z^{h}. It is desirable to perform an eighth operation of generating a fusion tensor z_{fusion} by inputting the tensors, whose dimensions are extended in the seventh operation, to the TFN and performing an operation thereon in a Cartesian product method, and a ninth operation of transmitting the fusion tensor z_{fusion} to a fully connected layer and classifying fatigue levels. In the seventh operation, the dimension of the video image feature tensor z^{v}, the voice feature tensor z^{a}, and the thermal image feature tensor z^{h} are extended for TFN operation. When extending the dimensions, it is desirable to fill the values of the extended dimensions with 1.

As described above, it is desirable the input data of each modality that is input to the corresponding submodel or subnet are converted into the processed tensors. Each tensor extends the dimension for TEN operation, and it is desirable to fill the value of the extended dimension with 1. It is desirable that the tensors of each modality, whose dimensions are extended, are input to the TFN. In the inside of the TEN, it is desirable to generate a new tensor z_{fusion} fused through the operation of three inputs in the Cartesian product method. In the present disclosure, when extending the dimension of the tensor corresponding to each modality, the corresponding dimension is filled with the value of 1, so that the values of each existing unimodal tensor and bimodal tensor are not damaged. Therefore, the fused tensor retains s the existing information corresponding to unimodal and bimodal tensors as well as a trimodal tensor newly generated by combining three modalities. Thereafter, the fused tensor may be input to the FCL, and a final fatigue level may be derived by applying a single sigmoid out layer.

In addition, in the fourth to sixth operations, the input data of each modality is input to the corresponding submodel (fTFN 1 model) or the corresponding subnet (fTEN 2 model) and converted into the processed tensor. First, the model to which the input data is input will be described as the fTFN 1 model, i.e., the submodel.

The respective modalities represented with quantitative data have different forms and dimensions. In order to achieve reasonable tensor fusion in this situation, the present disclosure provides a method of utilizing submodel to extract features from raw data of each modality. The submodel method is a method of extracting an appropriate feature by applying a specific model to an input, performing vector embedding, and defining the extracted feature as an input tensor. The submodel generates feature tensors for fusion of the three modalities, i.e., the video image feature tensor z^{v}, the voice feature tensor z^{a}, and the thermal image feature tensor z^{h}, with respect to the three inputs, i.e., the video image, the voice, and the thermal image. FIG. 1 illustrates the tensor fusion process, to which the submodel is applied, and the fusion tensor z_{fusion} newly represented through tensor fusion.

In the video image embedding among the submodel submodels, it is desirable to use video image captured through a general camera for about 1 minute after a subject for fatigue level measurement sits and looks straight ahead. The original resolution of the video image may be 1,280×720. However, it is also possible to capture and analyze video image with a resolution of higher than or lower than 1,280×720. For analysis, it is desirable to analyze one video image data by decomposing one video image data into a certain number of frames (k frames) selected in certain time units. It is more desirable to reduce each frame to a 3-channel image of a (H, W, 3) size for analysis. Desirably, the submodel applies an efficient net showing the highest performance in image analysis among CNN series in order to extract the features of the video image. It is desirable to extract the features of all frames decomposed in each video image, perform vector embedding, and concatenating the features into one feature to generate the video image feature tensor z^{v} for one entire video image. FIG. 2 illustrates the configuration diagram of the video image embedding submodel.

That is, in the fourth operation of generating the video image feature tensor z^{v}, it is desirable to perform vector embedding by extracting video image feature elements zᵢ^{j} in a vector format after the video image embedding submodel using the efficient net reduces the analysis target video image frame fᵢ^{j} into the 3-channel video image as illustrated in FIG. 2, and concatenate all of the video image feature elements zᵢ^{j} into one element to generate the video image feature tensor z^{v} as follows:

z^{v}=(zᵢ¹,zᵢ², . . . zᵢ^{k}), |z^{v}|=k*|zᵢ^{j}| where 0<i≤n (n: dataset size)
0<j≤k.

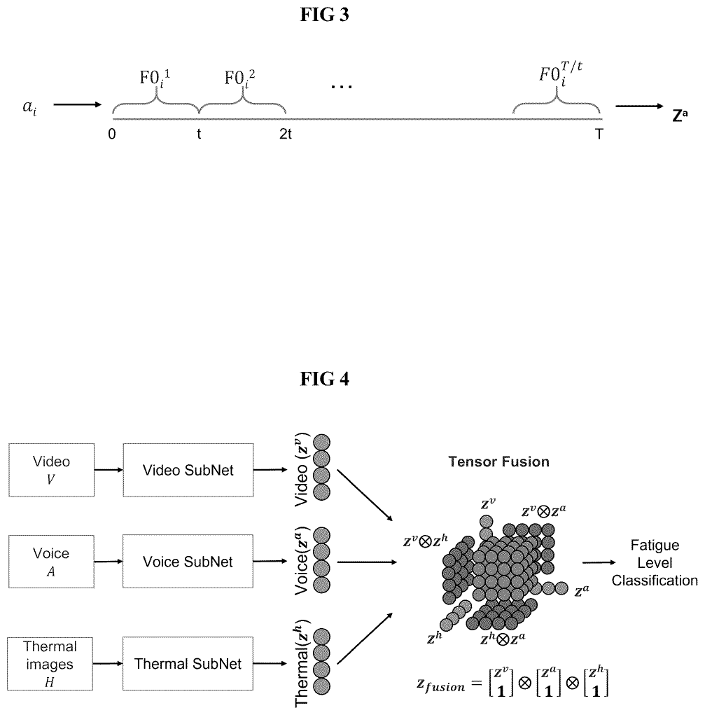

In the voice embedding submodel among the submodels, it is desirable that only the voice part is extracted from the video image data and used as the voice data. However, the voice data may also be extracted from the voice recorded with a separate recording device. One minute of raw voice data is represented with a vector having a size T=220,000. Since voice data has a very large size compared to video image and thermal image data, it can be said that the reduction ratio of voice data is the most important for tensor fusion within available resources. For voice data, in the case of the method using submodel, a model that extracts and uses an F0-mean value, i.e., a representative indicator of voice data, to extract features of voice data is proposed. As illustrated in FIG. 3, the F0-mean value for each specific section is extracted with respect to i^{th} voice input data aᵢ.

That is, as illustrated in FIG. 2, in the present disclosure, in the fifth operation of generating the video image feature tensor z^{a}, it is desirable to perform vector embedding by extracting F0-mean values for each specific section t with respect to i^{th} voice data aᵢ among voice data and concatenate all of the F0-mean values to generate the voice feature tensor z^{a} as follows:

$${z}^{a} = ( F {{0}_{i}}^{1} , F {{0}_{i}}^{2} , … , F {{0}_{i}}^{\frac{T}{i}} )$$

where 0<i≤n (n: dataset size).

In the thermal embedding submodel (thermal image submodel/subnet) among the submodels, thermal image data is image data captured by using a thermal camera. For analysis, it is desirable to analyze one video image data by decomposing one video image data into a certain number of frames (k frames) selected in certain time units. It is desirable to randomly extract and use k thermal images equal to the number of frames in video image data from among the thermal images. Since the thermal image has the same data format as the frame of the video image data, it is desirable to configure the submodel of the thermal image data in the same method as the method of the video image data to generate the thermal image feature tensor z^{h}.

That is, in the present disclosure, in the sixth operation of generating the thermal image feature tensor z^{h}, it is desirable that the thermal embedding image submodel using the efficient net performs vector embedding by extracting thermal image feature elements zᵢ^{j} in a vector format from the analysis target thermal image frame, and concatenates all of the thermal image feature elements zᵢ^{j} into one thermal image feature element to generate the thermal image feature tensor z^{h} as follows:

z^{h}=(zᵢ¹,zᵢ², . . . zᵢ^{k}), |z^{h}|=k*|zᵢ^{j}| where 0<i≤n (n: dataset size)
0<j≤k.

In addition, as described above, the present disclosure also proposes fTFN 2 model that extracts feature tensors by using the subnet, in addition to fTFN 1 model that performs tensor fusion by extracting feature tensors by using submodel. Although fTFN 1 model extracts features for each modal input, fTFN 2 model aims to define fusion tensors by reducing and processing data while maintaining the meaning of input data as much as possible by using the subnet. There is a great difference in the shape and size of the input data, i.e., video image, voice, and thermal image. Therefore, since the problem of unevenness of the input data must also be considered, the present disclosure provides fTFN 2 model using the subnet.

The video image embedding subnet among the subnets included in fTFN 2 model reduces, to one-dimensional vectors zᵢ^{j}, all decomposed frames through a relatively simple form of operation in which a global average pooling (GAP) layer and a channel extension through a dense net are applied to k frames decomposed from the input video image as illustrated in FIG. 5, and concatenates the one-dimensional vectors generated by all frames of the video image to generate the processed video image feature tensor z^{v} obtained by reducing the entire video image.

That is, in the fourth operation of generating the video image feature tensor z^{v} in fTFN 2 model, it is desirable that the video image embedding subnet reduces, to one-dimensional vectors zᵢ^{j}, the analysis target video image frame fᵢ^{j} through an operation to which a GAP layer and a channel extension through the dense net are applied, and concatenates the one-dimensional vectors zᵢ^{j} into one vector to generate the video image feature tensor z^{v} as follows:

z^{v}=(zᵢ¹,zᵢ², . . . zᵢ^{k}), |z^{v}|=k*|zᵢ^{j}| where 0<i≤n (n: dataset size)
0<j≤k.

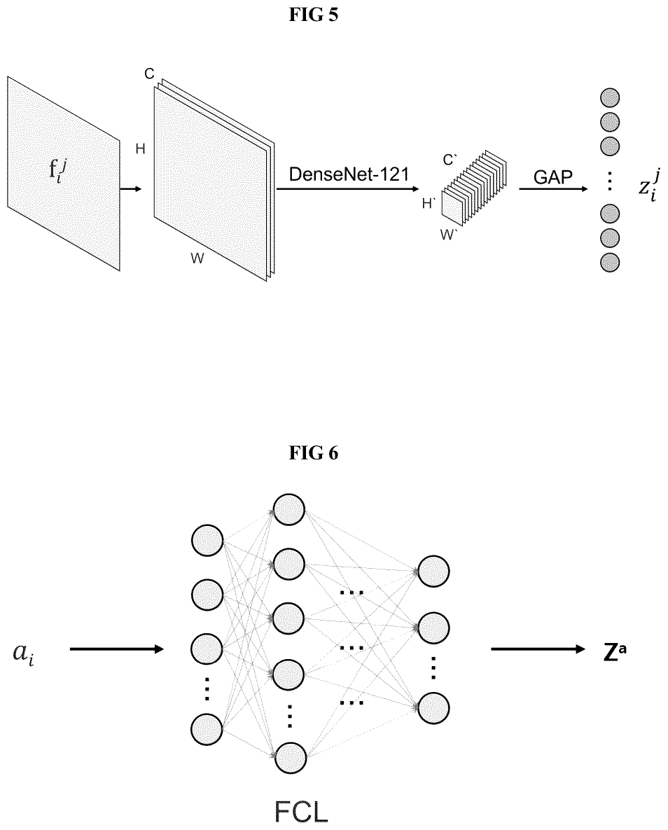

In addition, the voice embedding subnet among the subnets included in fTFN 2 model desirably applies only an FCL having a simple form illustrated in FIG. 6 in order to generated the processed input tensor that can reduce the input data to maintain original information as much as possible. It is desirable to configure the output layer of the FCL so that the size |z^{a}| of the voice feature tensor z^{a} is generated to be equal to the size of the output tensor in the submodel method.

That is, in the fifth operation of generating the voice feature tensor z^{a} in fTEN 2 model, it is desirable that the voice embedding subnet transmits, to the FCL, data for the i^{th} voice data aᵢ among the voice data to generate the voice feature tensor z^{a} as illustrated in FIG. 6.

It is desirable that the thermal embedding subnet among the subnets included in fTFN 2 model is configured in the same method as the method of the video image data to generate the video image feature tensor z^{h} for thermal data.

That is, in the fifth operation of generating the thermal image feature tensor z^{h} in fTFN 2 model, it is desirable that the thermal embedding subnet reduces, to one-dimensional vectors zᵢ^{j}, the analysis target video image frame hfᵢ^{j} through an operation to which a GAP layer and a channel extension through the dense net are applied, and concatenates the one-dimensional vectors zᵢ^{j} into one vector to generate the thermal image feature tensor z^{h} as follows:

z^{v}=(zᵢ¹,zᵢ², . . . zᵢ^{k}), |z^{v}|=k*|zᵢ^{j}| where 0<i≤n (n: dataset size)
0<j≤k.

Hereinafter, the present disclosure will be described in more detail with reference to experimental examples. The experimental examples described below are represented for a better understanding of the present disclosure, and it will be understood that the present disclosure may be variously modified and implemented differently from the experimental examples described herein. It is obvious to a person having ordinary skill in the art that various modifications and variations are possible within the scope and spirit of the present disclosure, and it is apparent that these modifications and variations fall within the scope of the appended claims.

### Experimental Examples

### 1. Fatigue Level Dataset

A biological signal collection system developed to collect human signals related to fatigue was used for this experiment. For this experiment, subjects were carefully selected and requested to collect data related to fatigue states thereof. FIG. 7 illustrates a data collection process.

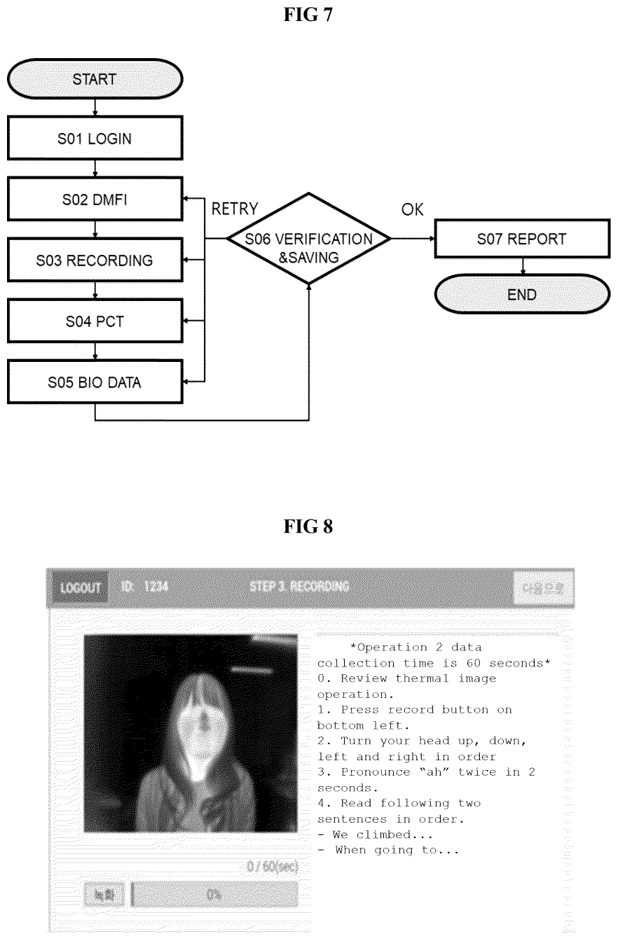

Information for data collection is displayed on a window of a data collection device as illustrated in FIG. 8. The subjects were requested to read a given script for about one minute, and video image and thermal images were recorded after starting reading. After the recording was ended, the subjects selected a subjective fatigue level from 1 (excellent) to 5 (extreme fatigue).

Next, an actual fatigue level was analyzed by using Daily Multiphasic Fatigue Inventory (DFMI), Psychomotor Cognitive Test (PCT), and blood, and saliva samples. Through these processes, data were collected and used for experiments. One dataset includes one minute of video image, voice, and thermal image and the fatigue level (1 to 5). In this experiment, only data corresponding to fatigue levels 1 and 5 were used, and a total of n=3, 450 datasets were used in the experiment.

### 2. Model Tuning

This experiment was for classifying fatigue levels 1 and 5, and all models were learned by using binary cross-entropy loss. Adam was applied as an optimizer, and learning was conducted for 100 epochs with a batch size of 16. The specific submodel/subnet setting environment was as follows.

Video Image/Thermal Embedding Submodel/Subnet: The video image data was captured with a general camera from the front while the data collection subject was sitting for one minute, and the resolution was 1, 280×720. Since the thermal image data also had a form similar to the video image data, the same method was applied. In this experiment, the analysis was conducted by setting the number of frames (images) used for each data of the video image and thermal image data to k=60, and each frame (image) was reduced to a 3-channel image having a size of W=224 and H=224 according to an efficient net input layer. In the submodel method, an FCL output layer was adjusted so that the size of the processed feature tensor for each image was 16. In the case of the video image subnet, DenseNet-121 model was applied to extend a channel of a frame to a size of W′=7, H′=7, and C′=16, and a size of a final output vector was determined through GAP.

Voice Embedding Submodel/Subnet: In the case of voice data, raw data had a very large size of T=220,000. In this case, a very high reduction ratio was required compared to the different two modalities, video image and thermal image, in order to solve a resource limitation problem during fusion. In this experiment, in the case of the submodel, features were generated by setting the extraction range of the F0-mean value to t=10,000. In the subnet, the output size of the FCL was set to 22, and the size of the processed voice feature tensor z^{a} of the voice data was |z^{a}|=22.

### Experimental Results

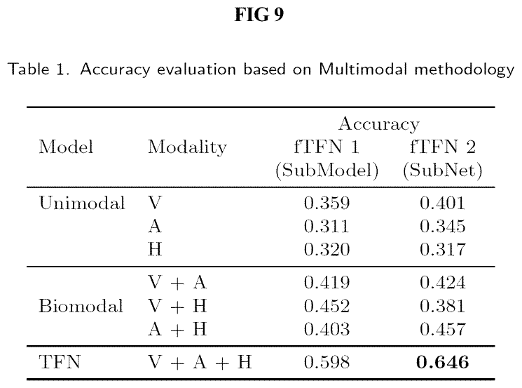

In a fatigue level classification experiment, performance in a unimodal environment and model performance in a multimodal (TFN) environment according to the combination of three modalities, video image (V), voice (A), and thermal image (H) are shown in FIG. 9. Model evaluation was conducted on 20% of test datasets. As a result of the experiment, it was confirmed that the classification performance in the multimodal system increased significantly compared to the performance in each unimodal classification system. Human fatigue is a qualitative state value, and there is a high probability that subjective judgment will intervene by the sense of the data collection subject. From this point of view, it is confirmed through the experimental results that the multimodal system can more realistically reflect human senses or emotions. In addition, the possibility of the multimodal system was identified in that a new qualitative state can be classified through quantitative states of video image, image, and voice data.

Although the present disclosure has been described with the various examples described above, the present disclosure is not necessarily limited to these examples and may be variously modified and implemented without departing from the technical spirit of the present disclosure. Therefore, exemplary embodiments disclosed in the present disclosure are not intended to limit the technical spirit of the present disclosure, but are intended to explain the technical spirit of the present disclosure. The scope of the technical spirit of the present disclosure is not limited by these exemplary embodiments. The protection scope of the present disclosure should be construed according to the Claims appended thereto, and all technical ideas within the equivalents should be construed as falling within in the protection scope of the present disclosure.

What is claimed is:

1. A fatigue level determination method using multimodal tensor fusion, in which an information system determines a person's fatigue level by analyzing a video image and a thermal image captured from the face of a person and a voice recorded from the person using a tensor fusion-based algorithm, the fatigue level determination method comprising:
a first operation of receiving a video image, a thermal image, and a voice simultaneously captured and recorded from a subject for a certain time as an analysis target of the subject;
a second operation of decomposing the video image and the thermal image received as the analysis target in frame units;
a third operation of selecting an analysis target video image frame and an analysis target thermal image frame from among frames of the video image and the thermal image decomposed in the second operation;
a fourth operation of generating a video image feature tensor z^{v} from the analysis target video image frame;
a fifth operation of generating a voice feature tensor z^{a} from voice data received as the analysis target;
a sixth operation of generating a thermal image feature tensor z^{h} from the analysis target thermal image frame;
a seventh operation of extending dimensions of the video image feature tensor z^{v}, the voice feature tensor z^{a}, and the thermal image feature tensor z^{h};
an eighth operation of generating a fusion tensor z_{fusion} by inputting the video image feature tensor z^{v}, the voice feature tensor z^{a}, and the thermal image feature tensor z^{h}, whose dimensions are extended in the seventh operation, to a tensor fusion network (TFN) and performing an operation thereon in a Cartesian product method; and
a ninth operation of transmitting the fusion tensor z_{fusion} to a fully connected layer and classifying fatigue levels.

2. The fatigue level determination method according to claim 1, wherein, in the fourth operation, an image embedding submodel using the efficient net performs vector embedding by extracting video image feature elements zᵢ^{j} in a vector format, reduces the analysis target video image frame fᵢ^{j} into a 3-channel video image, and concatenates all of the video image feature elements zᵢ^{j} into one element to generate the video image feature tensor z^{v} as follows:
z^{v}=(zᵢ¹,zᵢ², . . . zᵢ^{k}), |z^{v}|=k*|zᵢ^{j}|

where 0<i≤n (n: dataset size) 0<j≤k.

3. The fatigue level determination method according to claim 1, wherein, in the fifth operation, a voice embedding submodel performs vector embedding by extracting F0-mean values for each specific section t with respect to i^{th} voice data aᵢ among the voice data, and concatenates all of the F0-mean values into one value to generate the voice feature tensor z^{a} as follows:
$${z}^{a} = ( F {{0}_{i}}^{1} , F {{0}_{i}}^{2} , … , F {{0}_{i}}^{\frac{T}{i}} )$$

4. The fatigue level determination method according to claim 1, wherein in the sixth operation, a thermal embedding submodel using the efficient net performs vector embedding by extracting thermal image feature elements zᵢ^{j} in a vector format from the analysis target thermal image frame hfᵢ^{j}, and concatenates all of the thermal image feature elements zᵢ^{j} into one element to generate the thermal image feature tensor z^{h} as follows:
z^{h}=(zᵢ¹,zᵢ², . . . zᵢ^{k}), |z^{h}|=k*|zᵢ^{j}|

where 0<i≤n (n: dataset size) 0<j≤k.

5. The fatigue level determination method according to claim 1, wherein in the fourth operation, an image embedding subnet reduces, to one-dimensional vectors zᵢ^{j}, the analysis target video image frame fᵢ^{j} through an operation to which a global average pooling (GAP) layer and a channel extension through a dense net are applied, and concatenates the one-dimensional vectors zᵢ^{j} into one vector to generate the video image feature tensor z^{v} as follows:
z^{v}=(zᵢ¹,zᵢ², . . . zᵢ^{k}), |z^{v}|=k*|zᵢ^{j}|

where 0<i≤n (n: dataset size) 0<j≤k.

6. The fatigue level determination method according to claim 1, wherein in the fifth operation, a voice embedding subnet transmits, to a fully connected layer (FCL), data for i^{th} voice data aᵢ among the voice data to generate the voice feature tensor z^{a}.

7. The fatigue level determination method according to claim 1, wherein in the sixth operation, a thermal embedding subnet reduces, to one-dimensional vectors zᵢ^{j}, the analysis target video image frame hfᵢ^{j} through an operation to which a GAP layer and a channel extension through a dense net are applied, and concatenates the one-dimensional vectors zᵢ^{j} into one vector to generate the thermal image feature tensor z^{h} as follows:
z^{v}=(zᵢ¹,zᵢ², . . . zᵢ^{k}), |z^{v}|=k*|zᵢ^{j}|

where 0<i≤n (n: dataset size) 0<j≤k.

8. The fatigue level determination method according to claim 1, wherein in the seventh operation, when the dimensions of the video image feature tensor z^{v}, the voice feature tensor z^{a}, and the thermal image feature tensor z^{h} are extended, the dimensions of the video image feature tensor z^{v}, the voice feature tensor z^{a}, and the thermal image feature tensor z^{h} are filled with a value of 1.
